(19) United States
(12) Patent Application Publication
(10) Pub. No.: US 2011/0267436 A1
(43) Pub. Date: Nov. 3, 2011

(54) Nanowire Bonding Method and Apparatus

(75) Inventors: Mehdi Yazdanpanah, Louisville, KY (US); Romaneh Jalilian, Lousiville, KY (US)

(73) Assignee: NAUGANEEDLES LLC, Louisville, KY (US)

(21) Appl. No.: 13/098,593

(22) Filed: May 2, 2011

Related U.S. Application Data
(60) Provisional application No. 61/330,123, filed on Apr. 30, 2010.

(51) Int. Cl. H04N 13/02; B05C 11/10; B05C 11/105

(52) U.S. Cl. 348/47; 427/98.4; 118/668; 348/E13.074; 977/762

(57) ABSTRACT

The present invention provides method for creating point to point metallic contact and bridges between two structures at the nanoscale. Embodiment methods permit for the formation of individual and arrays of silver-gallium nanostructures bridges by mobilizing a gallium microdroplet and bringing in contact with silver coated surface. The invention also describes an example instrument for formation of individual and multiple nanostructure bridges at selective location and orientation. Example structures including multiple nanostructure bridges on the top of each other, suspended nanostructure sensors and actuators, nanowire bonded that provides electrical contacts between nanostructures (e.g. carbon nanotube, Graphene, nanowires) and microelectronic circuits are enabled by this invention.

### CROSS REFERENCE TO THE RELATED APPLICATIONS

This application claims the benefits of the provisional patent application 61/330,123 filed on Apr. 30, 2010.

### STATEMENT OF GOVERNMENT INTEREST

This invention was made with Government support under Grant #IIP-0944435 awarded by National Science Foundation and Grant #KSTC184-512-10-082 awarded by Kentucky Science Technology Corporation. The government has certain rights in the invention.

### BACKGROUND OF THE INVENTION

Self-assembly of metallic nanostructures through the evolution of material systems toward states of thermodynamic equilibrium has been known. Creation of numerous different structures has been demonstrated by self-assembly process and is as a result of the complex physics of metal systems. Transformation between states, or phases, of matter is a function of various state variables such as temperature, pressure or composition. A change in a thermodynamic variable of an alloy system causes the system to evolve toward a new state of equilibrium, and a new state of the material.

Self-assembly methods offer less laborious and simpler fabrication approaches for materials, structures, and devices than traditional fabrication methods. With the continually decreasing feature sizes in the field of nanostructure fabrication, and the cost of traditional fabrication methods being considerable, the application of self-assembly methods is predicted to stay appealing.

Developing processes that exploit adequately controllable self-assembly methods, that also demonstrate precision, and repeatability has great potential to reduce manufacturing costs of current conventional fabrication processes. These methods can potentially be used in the fabrication of integrated devices such as micro electro mechanical systems (MEMS), BioMEMS, Microflips, and Lab-on-a-chip devices.

One prerequisite to success in the field, is the ability to securely attach nanowires at desired locations. General approaches used are as follows. One method is using mechanical or fluidics means to transport a nanostructure to a location proximate to the target and applies an electric field or electron beam to attach the object. A second class of methods is to grow nanowires on chemically patterned surfaces. Although nanowires can be grown selectively from catalyst nanoparticles by plasma enhanced chemical vapor deposition, due to the small size of the particles, the required positioning of the nanoparticles at selected locations can be quite difficult. Also, high temperatures in the PECVD and other chemical vapor deposition (CVD) methods can damage the substrate material. However, the goal in all of these approaches has been to attach one end of the nanostructures to only one point of another material, and nanostructures were never seen as means for electrical connections between two or more conductors.

In the past two decades several nano nanomaterial (e.g. nanowires, nanotubes) have been discovered and their very unique electrical and mechanical properties have been demonstrated using state-of-the-art E-Beam nanolithography approach. However, the key limitations of E-Beam lithography are (1) low throughput, (i.e., the very long processing time), (2) high complexity of the process, and (3) being a serial process. Therefore, using E-Beam lithography, it would be very difficult to fabricate inexpensive nanostructure based devices integrated into microelectronic circuits.

### SUMMARY OF THE INVENTION

In one embodiment of the present inventions, a nano wire-bonding (NWB) instrument is used for electrical wire bonding of nanostructure at the nanoscale. In this embodiment, by mobilizing a gallium droplet, the instrument is capable of creating electrical contact with nanostructures by forming an ohmic contact, via a silver-gallium (Ag₂Ga) nanowire, between the nanostructures and the micro pattern in a device. In one embodiment, the instrument is further capable of: (1) Growing nanowires at any selective location and orientation while controlling the length and diameter of nanowires; (2) Growing nanowires that are clamped between two sub-micrometer size patterns (coated with silver) and electrically connecting them; (3) Growing freestanding nanowires at selected location.

In one embodiment the elements and steps of the novel NWB method are: (1) A micromanipulator capable of moving a nozzle or tungsten probe with sub 100 nm resolution; (2)

A micropipette with nozzle as small as 1 to 50 μm; (3) A mechanical syringe to inject gallium into the nozzle. The pressure is adjusted to control the flow of gallium and the size of the droplet; (4) in this embodiment, gallium interacts with the silver film, forming Ag₂Ga nanowires, when gallium touches silver. In this embodiment, gallium only sticks to a few metals (silver, gold, aluminum, etc) and does not stick to silicon or silicon oxide, therefore even if the gallium droplet is larger than the silver pattern, liquid gallium self-aligns and no gallium residue is deposited on the area around the silver pattern; (5) In one embodiment, to enhance the needle formation, the nozzle is coated prior to filling it with gallium. This step enhances the wetting effect of gallium in the micropipette and facilitates the gallium fellow. In addition, solution of the silver into the gallium increases the yield of the formation of the nanowire; (6) In one embodiment, Ga droplet size is controlled by the Nozzle size and the pressure is applied by the syringe. Gallium droplet size, the thickness of silver film on the pattern, thickness of the silver film coated on the nozzle, the time that the droplet is in contact with the substrate, and the puling speed are the parameters that can control the length and diameter of the formed nanowires.

In other embodiments, other metal substrates such as platinum, gold, etc may be used for fabrication of different shape nanostructures.

### BRIEF DESCRIPTION OF THE DRAWINGS

FIG. 1 shows the novel method of growing of nanowires and double clamped structures by mobilizing liquid gallium contained by a funnel-shape applicator.

FIG. 2 shows the novel method of growing freestanding nanowires on several different features by mobilizing liquid gallium contained by a funnel-shape applicator.

FIG. 3 shows a typical mechanical syringe which was used to inject gallium into the micropipette as in one embodiment of the present invention.

FIG. 4 shows the novel method of growing nanowire bondings from mobilized liquid gallium droplet on and by a tungsten probe.

FIG. 5 shows the novel method of growing nanowire bondings from mobilized liquid gallium contained by a micropipette having a droplet nozzle that is connected to a micromanipulator and is observed under two optical cameras.

FIG. 6 shows the novel apparatus for growing multiple nanowires for bonding purposes that provide electric contact to integrate nanostructure based devices into microelectronic circuit.

### DETAILED DESCRIPTION OF THE PREFERRED EMBODIMENTS

The present invention, in one embodiment, enables a novel nono-device fabrication capability that can be adopted by the microelectronics industry. Nanowire Bonding (NWB) impacts a much broader set of technologies. NWB provides a set of tools to the scientists and technologists enabling them to quickly and inexpensively characterize electrical and electromechanical properties of the nanostructures. Using embodiments of the present invention, many novel nanostructure based devices are fabricated and evaluated for various applications and a much broader class of Nanoelectromechanical Systems (NEMS) could be produced very cost effectively. Since the NWB are fabricated with high throughput, it is expected to be adopted by micro/nanoelectronic industry for integrating nanostructures into electronic circuits

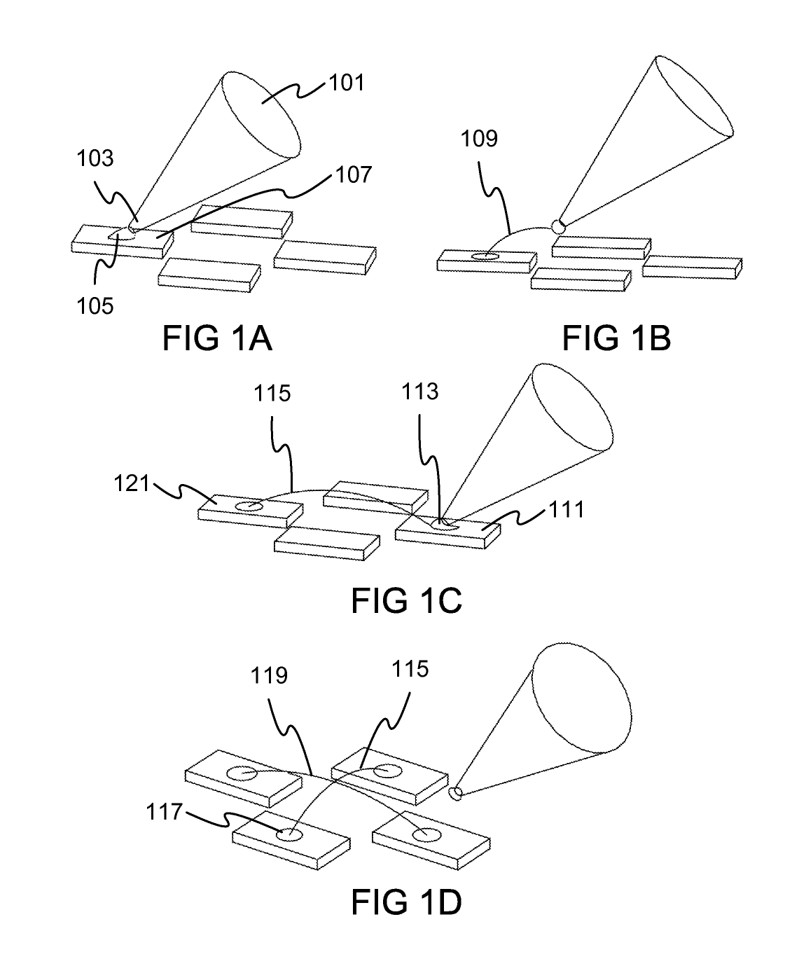

As shown in FIG. 1, based on this embodiment, a process is developed to selectively form Nano-Wire-Bonds (115) between two metallic micro-pattern (107) based on the interaction of gallium (113) with silver at room temperature and in ambient conditions.

In one embodiment, suspended nanostructures of silver-gallium (115, 119) are clamped between two patterns of silver (107 and 111) pads that are made by standard optical photolithography. Using a micromanipulator (211), a micro nozzle (103) filled with molten gallium (105) is brought in contact with silver pads (107). In this embodiment, the gallium droplet (105) interacts with the silver to form conductive Ag₂Ga nanowires (109) at room temperature. By pulling the micro nozzle from the pad, a single Ag₂Ga nonowire forms between the pad and the gallium drop (109). Further pulling the nozzle and touching (113) the other silver pad (111), causes the Ag₂Ga nanostructure (115, 119) to be clamped into the other silver pad (111) and suspend between the two silver pads (111, 121). The gallium droplets (113) placed on the contact pads do not spread out across the entire surface of the chip, but instead follow the path defined by the patterned silver (117).

As shown in FIG. 1A-D, in one embodiment, the method or process of making Ag₂Ga nanowires comprises the following. A gallium droplet (105) that is delivered through a funnel's (101) nozzle (103), touches a silver pad/pattern/feature (107). Immediately, Ag₂Ga are formed. By pulling the funnel (101) a single nanowire (109) is formed between the funnel (101) and the pad (107). By touching the funnel (101) into the other pad (111), the nanowire (115) adheres to the second pad (111). In a further embodiment, a second nanowire (119), is similarly formed and passes above the first one (115) electrically connecting other layers/patterns/features making three dimensional features or contacts. Multiple nanowires can be formed on the top of each other.

In an embodiment of the present invention, a method for growing nanostructures comprises forming a pattern on a substrate (107), loading liquid gallium in a micropipette (101) having a nozzle (103); and applying pressure to the micropipette by a mechanical syringe to dispense the liquid gallium in the form of a droplet (105). In this embodiment, the micropipette (101) is guided by a micromanipulator.

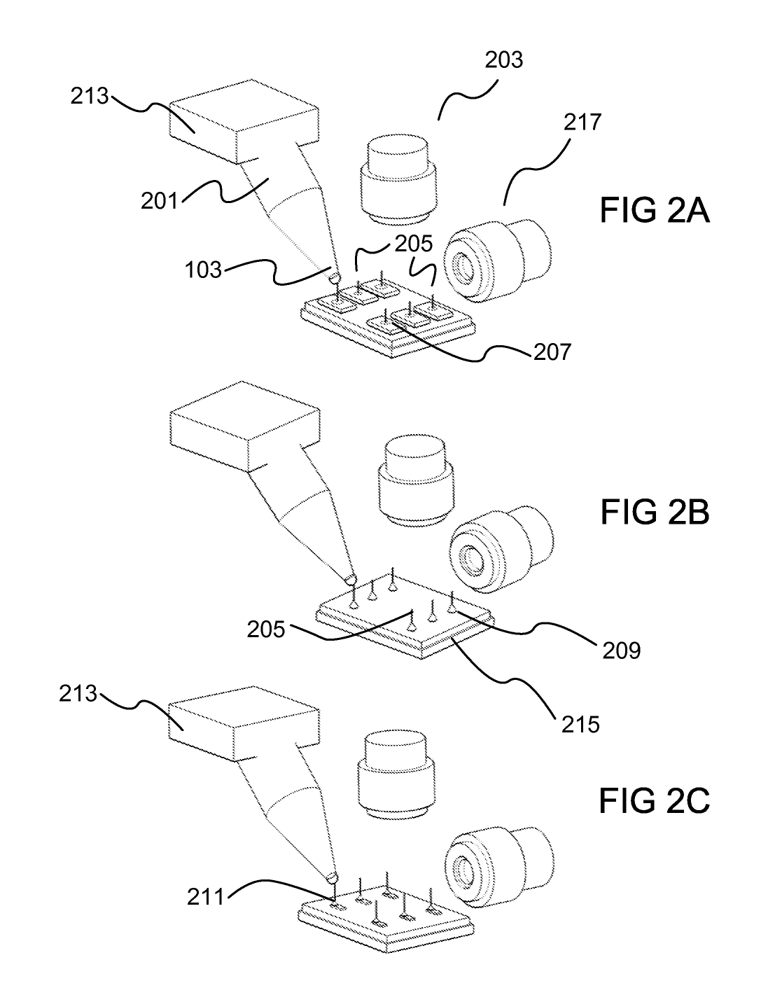

As shown in FIGS. 2A through 2C, in a further embodiment of the present invention, using at least one micromanipulator (211) and one high resolution optical lens (203) it is possible to make free standing Ag₂Ga gallium (205) by mobilizing Gallium droplet (105) and bringing in contact with silver patterns (207) on the substrate (215). Since the entire process is performed under optical microscope (203) in ambient air, it has the potential of being adopted by the microelectronic industry for device fabrication. Further, the optical setup of this embodiment, provides a side view and a top view using side view (217) and top view (203) lenses.

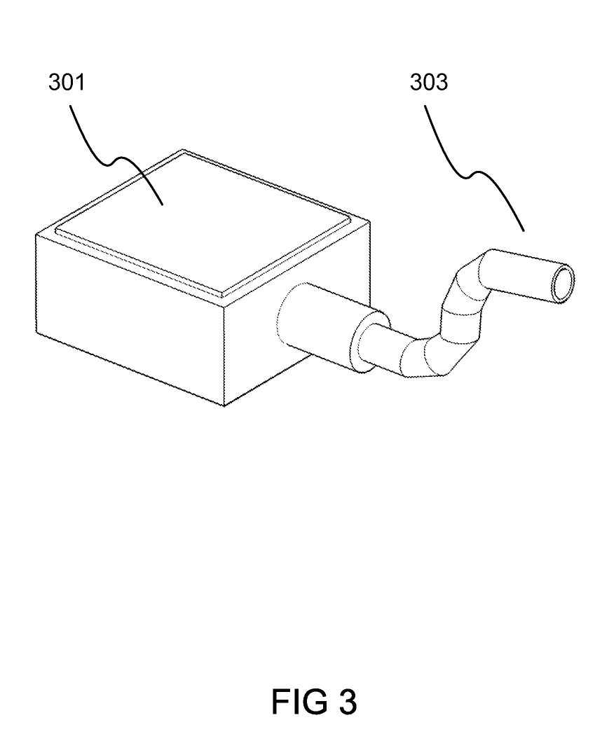

As in FIG. 2A-C, in one embodiment, the key elements of the NWB include; (1) A micromanipulator capable of moving a nozzle (103) or a tungsten probe as shown in FIG. 3 (301) with sub 100 nm resolution; (2) A micropipette (201) with nozzle (103) as small as 1 to 50 um; (3) A mechanical syringe (not shown in the figure) to inject gallium into the nozzle (103). The pressure is adjustable to control gallium flow and droplet size.

As shown in FIG. 2A-C, in one embodiment, the patterns are Atomic Force Microscopy probes (211) and (207) and (209) are microstructures that freestanding nanowires (205) are formed on them. In one embodiment, metal pattern is made from silver, platinum, gold, aluminum, copper, cobalt or iron and in another, the features are micro cones (209).

FIG. 3 show a typical mechanical syringe used in one embodiment of present invention. This example syringe has a body (301) which creates the desired displacement of liquid gallium, and an outlet (303) that is connected to the micropipette (201) as used in one embodiment of the present invention.

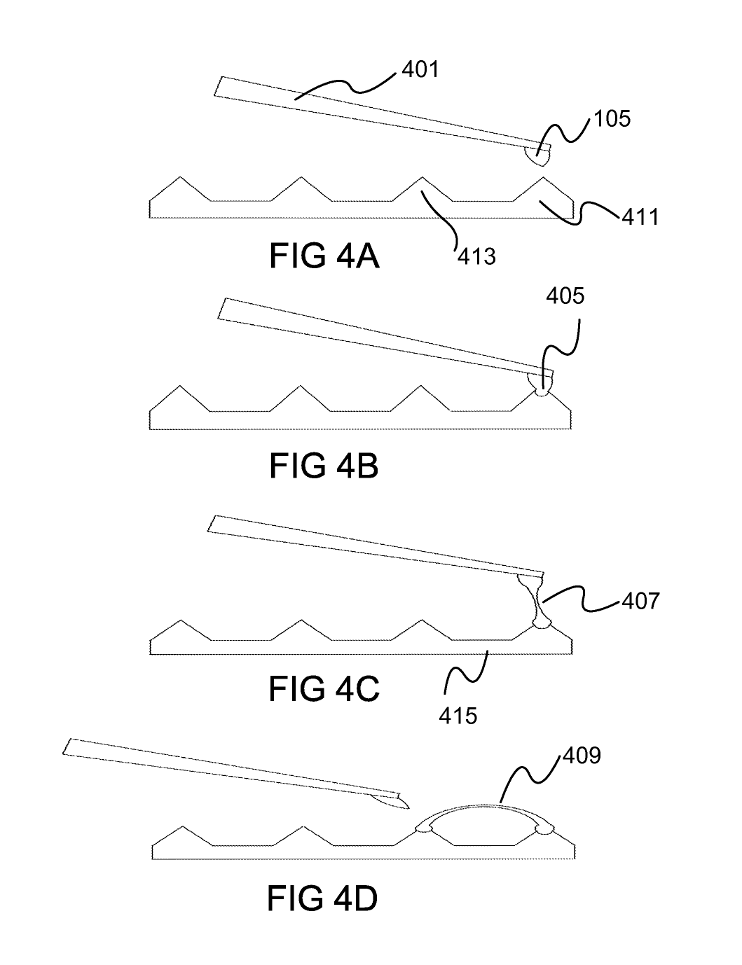

FIG. 4A-D shows an embodiment of wire bonding between two silver coated micro-cones (411, 413). By dipping a tungsten wire/probe into a bath of molted gallium, a droplet of gallium (5 um to 100 um) (105) is attached to the wire (401). The probe (401) is brought to contact with the first microcone (411) and pulled away and brought to contact with the second cone (413) and make the bonding.

As shown in FIG. 4A-D, in an alternative embodiment, suspended nanostructures or links (409) are created between two or more features (e.g. 411, 413) on the patterns located on the substrate (415). In this embodiment, the applicator (401) carrying liquid gallium (105) touches down on a feature (411), and is then gradually moved away from the feature (411), starting the growth of the nanostructures (407), following by another touch of the applicator, this time to another feature (413). In this embodiment, this action can be continued so that multiple spots/locations or features are connected mechanically or electrically.

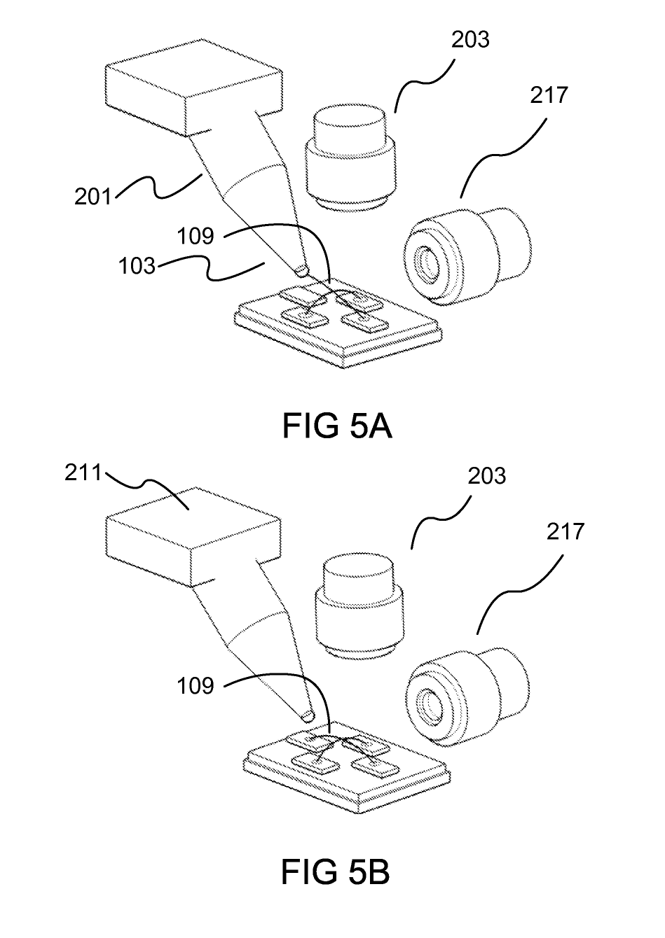

In another embodiment, the nanostructures (109) bridge over one another as shown in FIG. 5A-B.

In the embodiment shown in FIGS. 5A and 5B, an optical setup was designed and implemented for the purpose of visual monitoring of the micromanipulation operations. The optical setup included two cameras with two lenses providing top view and side view (203 and 217, respectively), a display; and a Personal Computer (PC). In this embodiment, the images fed to the PC by the cameras are processed in the PC and two or three dimensional views of the nanostructures and the patterns are created. Further, the optical lenses (203, 217) provide magnification for the micromanipulation.

In an alternative embodiment of the present invention, nanostructures are grown by the following steps: forming a pattern on a substrate, a solid probe (401) carrying liquid gallium; and the liquid gallium (105) being mobilized by the solid probe (401). In this embodiment, the solid probe (401), instead of a micropipette, is guided by a micromanipulator. In a further embodiment, the solid probe (401) is made of tungsten.

In one embodiment the tip of the wire/probe (micronozzle) has a high aspect ratio and is in microscale range (between 1 to 10 um) and the micropipette is highly flexible.

In an embodiment, the internal surface of the micropipette is coated (by for example silver, platinum, gold, aluminum, copper, cobalt or iron) to facilitate the flow of gallium.

In one embodiment, high precision micro injection system, injects small amount of liquid gallium.

In one embodiment, gallium metal in liquid phase mixed with Ag₂Ga crystals in solid Phase are used for better ohmic contacts.

In an embodiment of the present invention, nano wire-bonding (NWB) methods include the following. An instrument for wire bonding and nanostructure fabrication at the nanoscale: by mobilizing a gallium droplet, an instrument is designed capable of making different configuration of Ag₂Ga nanowires. The instrument is capable of: (1) Growing nanowires at any selective location and orientation while controlling the length and diameter; (2) Growing nanowires that are clamped between two sub micrometer size pattern (coated with silver) and electrically contact them; (3) Growing freestanding nanowires at selected location.

In one embodiment, upon touching the gallium droplet to the silver patterns, gallium interacts with the silver film, forming Ag₂Ga nanowires. Gallium only adheres to a few metals (silver, gold, platinum, iron, cobalt, aluminum, etc.) and does not adhere to silicon or silicon oxide. Therefore, even if the gallium droplet is larger than the silver pattern, gallium self aligns with the silver film and no gallium residues are deposited on the area around the silver pattern. Other liquid metals such as mercury, cesium, etc. may be used for other metal crystalline structures.

In one embodiment, to enhance the needle formation, the nozzle is coated with metal such as silver, gold, platinum, iron, cobalt, aluminum, etc, prior to filling it with gallium. This step enhances the gallium wetting to the micropipette and facilitate the gallium follow. In addition, silver film is dissolved into the gallium and this increases the yield of the formation of the nanowire.

In one embodiment, gallium droplet size is controlled by the Nozzle size. Gallium droplet size, the thickness of silver film on the pattern, thickness of the silver film coated on the nozzle, the time that the droplet is in contact with the substrate, and the puling speed are the parameters that can control the length and diameter of the formed nanowires.

In other embodiments, other metal substrates such as platinum, gold, etc may be used for fabrication of different shape nanostructures or coating of the nozzle area. In yet other embodiments, other liquid metals such as mercury, cesium, etc. may use for other metal crystalline structures. In still other embodiments, other metal such as palladium (Pd), rhodium (Rh), ruthenium (Ru), iridium (Ir), osmium (Os), or alloy thereof are considered and used.

In other embodiments, the substrates are Silicon, germanium, or gallium containing substrates. In yet other embodiments of the present invention, aluminum or indium is mobilized for fabricating the nanostructures.

In one embodiment, prior to loading mechanical syringe or micropipette with the liquid gallium, the nozzle is coated with a material such as silver, platinum, gold or aluminum.

In another embodiment, to control the flow of liquid gallium and to control the size of the droplets, adjustable pressure is applied to the mechanical syringe (FIG. 3), and the droplets dispense through the nozzle of the micropipette. In a further embodiment, of the present invention, the size of the nozzle is adjusted in order to control the size of the droplet.

In one embodiment, excess amounts of the liquid gallium, fuse exclusively to the patterns due to selective adherence of the liquid gallium to the patterns. Therefore, no quantities of the liquid gallium directly contacts the substrate.

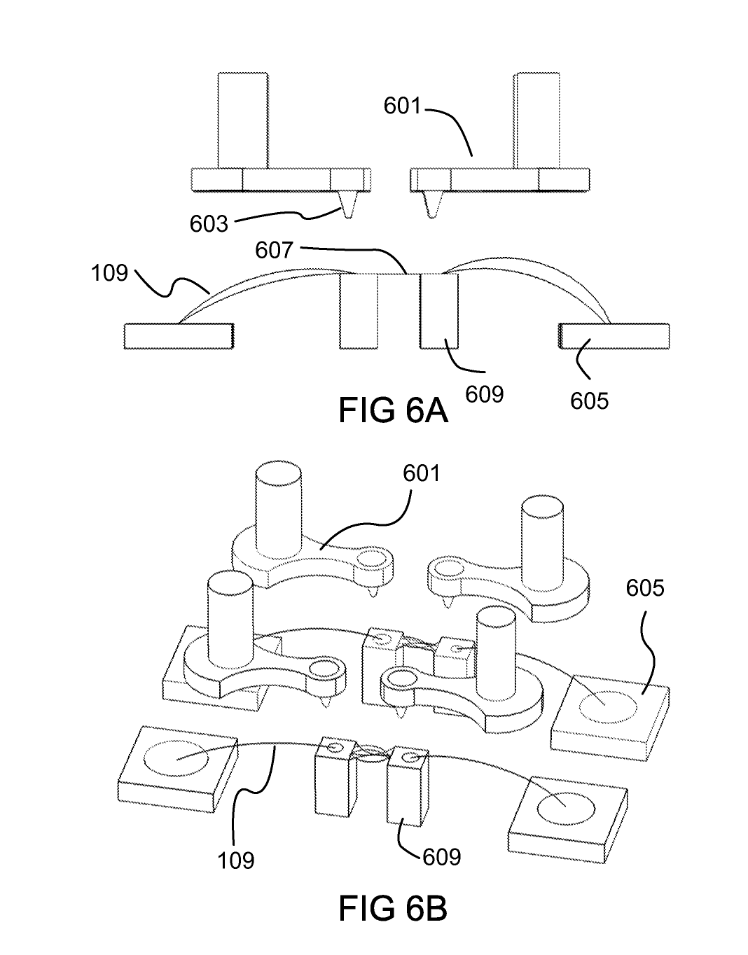

In one embodiment as shown in FIG. 6, inexpensive nanostructure-based devices are fabricated which are integrated into microelectronic circuits (605). As shown in FIG. 6, by adding multiple micro nozzle (603) the process can be done in parallel with very high throughput.

In one embodiment, the nanostructures are used for sensing applications including similar to sensing applications micro cantilever beams are used for.

A further embodiment of the present invention aims to develop a high throughput and low cost process and tool to make electric contact with nano-materials (e.g. nanotubes and nanowires) and integrate them into electronic circuits. This exemplary method will have enormous impact on using nanomaterial in the chip manufacturing industry.

In a further embodiment, the processes of NWB is performed in parallel as shown in FIG. 6A-B. As shown in FIG. 6A-B, in another embodiment of the present invention, a NWB machine is created to establish electrical connection between nanomaterial (607) (e.g. Graphene carbon nanotube, nanowires) and microelectronic circuit (605) on a pattern on a substrate by growing Ag₂Ga nanowire bond between 605 and 609 nanostructures. The machine in this embodiment comprises of micromanipulators, micropipettes (601) each with at least a nozzle (603), and mechanical syringes (not shown). In this embodiment, the nozzles are guided by multiple micromanipulators. In a further example of this embodiment, the micromanipulators are operating independently of each other.

In one embodiment, the NWB machine grows the nanostructures on predetermined locations on the pattern of the substrate, with various orientations, and with control over the dimensions of the nanostructures. In an alternative embodiment, the NWB machine, simultaneously grows many nanostructures in a parallel process.

A system, an apparatus, a device, or an article of manufacture comprising one of the following items is an example of the invention: nanostructures, nanowires, micromanipulation, micropipettes, silver coatings, gallium droplets, silver-gallium droplets, nano-bonds, applying the method mentioned above, for the purpose of the current invention or nanowire bonding.

An apparatus, device, or an article of manufacture comprising any one of the items mentioned in the above embodiments is an example of the invention. A method comprising one of the following steps, features, or items is an example of the invention: mobilizing gallium in liquid phase, creating gallium droplets, bringing into contact the galliums droplets into coated substrates, pulling the applicator from the substrates, creating nanostructures, or using the apparatus or system mentioned above, for the purpose of the current invention or nanowire/nanostructure bonding.

Any variations of the above teaching are also intended to be covered by this patent application.

1. A method for growing nanostructures comprising;
forming a pattern on a substrate,
loading liquid gallium in a micropipette having a nozzle; and
applying pressure to the micropipette by a mechanical syringe to dispense said liquid gallium in the form of a droplet;
wherein said micropipette is guided by a micromanipulator and brought in contact with said pattern.

2. The method of claim 1 wherein said patterns are Atomic Force Microscopy probes.

3. The method of claim 1, wherein said nanostructures are nanowires.

4. The method of claim 1, wherein said pattern is made by metal films made of one or more metals selected from the group consisting of silver, platinum, gold, aluminum, copper, cobalt, iron, palladium, rhodium, ruthenium, iridium, and osmium.

5. The method of claim 1, wherein said nozzle is coated with a material made from one or more material chosen from the group consisting of silver, platinum, gold, aluminum, copper, cobalt, iron, palladium, rhodium, ruthenium, iridium, and osmium prior to loading of said mechanical syringe with said liquid gallium.

6. The method of claim 1, wherein to control the flow of liquid gallium and to control the size of said droplets, adjustable pressure is applied to said mechanical syringe, and said droplets dispense through said nozzle of said micropipette.

7. The method of claim 1, wherein the size of said nozzle is adjusted in order to control the size of said droplet.

8. A method for growing nanostructures, comprising;
forming a pattern on a substrate,
a solid probe carrying liquid gallium; and
said liquid gallium being mobilized by said solid probe;
wherein said solid probe is guided by a micromanipulator.

9. The method of claim 8, wherein said solid probe is made of tungsten.

10. The method of claim 1, wherein excess amounts of said liquid gallium, fuse exclusively to said patterns due to selective adherence of said liquid gallium to said patterns and wherein no quantities of said liquid gallium directly contacts said substrate.

11. The method of claim 1, for establishing links between two or more features on said patterns located on said substrate by commencing said growth of said nanostructures on a first feature, gradually moving away from said first feature while growing said nanostructures, touching subsequent features, likewise moving away from said subsequent features while continuing said growth of said nanostructures, and terminating said growth of said nanostructures at a last feature.

12. The method of claim 11, wherein said nanostructures bridge over one another.

13. An apparatus for establishing connection between two or more features on a pattern on a substrate by growing nanostructures, said apparatus comprising:
a plurality of micromanipulators;
a plurality of micropipettes each with a nozzle; and
a plurality of mechanical syringes;
wherein said micropipettes are guided by said micromanipulators.

14. The apparatus of claim 13, wherein said micromanipulators are operating independently of each other.

15. The apparatus of claim 13, wherein said apparatus growing said nanostructures on predetermined locations on said pattern of said substrate.

16. The apparatus of claim 13, wherein said apparatus growing said nanostructures with various orientations.

17. The apparatus of claim 13, wherein said apparatus controlling the dimensions of said nano structures.

18. The apparatus of claim 13, simultaneously growing a plurality of nanostructures in a parallel process.

19. An apparatus for the purpose of visual monitoring of micromanipulation of claimed 1, the apparatus comprising:
at least two cameras;
at least two optical lenses;
at least one display; and
at least one image processor computer;
wherein said image processor computer renders three dimensional views of said nanostructures and said patterns from two dimensional images provided by cameras, and said optical lenses provide magnification for said micromanipulation.
